(19) United States
(12) Patent Application Publication
(10) Pub. No.: US 2009/0245112 A1
(43) Pub. Date: Oct. 1, 2009

(54) COMMUNICATION DEVICE, COMMUNICATION SYSTEM, COMMUNICATION CONTROL METHOD AND RECORDING MEDIUM

(76) Inventor: KOUHEI OKAZAKI, Tokyo (JP)

Correspondence Address: NEC CORPORATION OF AMERICA, 6535 N. STATE HWY 161, IRVING, TX, 75039, US

(21) Appl. No.: 12/408,223

(22) Filed: Mar. 20, 2009

(30) Foreign Application Priority Data
Mar. 25, 2008 (JP) 2008-078358

(51) Int. Cl. H04L 12/24

(52) U.S. Cl. 370/236; 370/235

(57) ABSTRACT

The present invention provides a communication system that is capable of performing band control on a LAG group between devices. A communication system according to the present invention includes multiple communication devices (M1, M2, and E1 to E3). Each of the communication devices (E1 to E3) manages output ports of a LAG (Link Aggregation) group between the devices (M1 and M2) for each LAG group. Each of the communication devices (E1 to E3) controls flows transmitted from the output ports for each LAG group, when traffic of the output ports deviates.

This application is based upon and claims the benefit of priority from Japanese patent application No. 2008-078358, filed on Mar. 25, 2008, the disclosure of which is incorporated herein in its entirety by reference.

### BACKGROUND OF THE INVENTION

1. Technical Field

The present invention relates to a communication device, a communication system, a communication control method, and a recording medium recording a communication control program that include LAG (Link Aggregation) functions. Specifically, the present invention relates to a communication device, a communication system, a communication control method, and a recording medium recording a communication control program for performing band control on a LAG (Link Aggregation) group between devices.

2. Background Art

The LAG (Link Aggregation) functions, defined in IEEE802.3ad, realize communication between devices by connecting a device with a partner device via a plurality of physical links and virtually handling the plurality of physical links as a single logical link. The LAG functions can provide two advantages below:

1. The LAG functions can increase the band of a single virtual physical link to the sum of bands (total band) of all physical links constituting the LAG group.

2. The LAG functions can provide redundancy for a circuit such that even if any of the physical links fails and becomes unable to handle communication, the remaining physical links can continue the communication.

U.S. Pat. No. 6,910,149 (Patent Document 1) discloses a technique for realizing the LAG functions between devices (LAG functions between devices).

The LAG functions between devices allow the devices to exchange information between communication devices and manage the LAG group between the devices. Accordingly, a communication device that connects with the communication devices in the LAG group can communicate with the communication devices as if it is communicating with a single communication device that supports the LAGs.

With the LAG functions between devices applied to a plurality of communication devices, even if one of the communication devices fails, the other communication devices can continue the communication. That can prevent affection of the failure to the entire network.

The LAG functions also have an advantage of virtually increasing the band by bundling the plurality of physical links. In that case, however, one of the plurality of LAG ports needs to be selected to output in the LAG group that is a bundle of a plurality of physical links.

Since IEEE802.3ad does not define any rule for selecting a LAG port, a LAG port is selected generally according to a computational algorithm based on values in a header field of a transmission frame (MAC address, VLAN tag, IP address, and the like). Some computational algorithms and values in the header field of the transmission frame may cause biased selection of the LAG port.

U.S. Pat. No. 6,910,149 (Patent Document 1) refers to a technique for configuring a LAG group between devices and techniques in switching and restoring operations in case of a failure but does not refer to band control of the LAG group between devices.

Japanese Patent Laid Open Publication No. 2002-232427 (Patent Document 2) discloses a technique for ensuring band availability and performing variable control on a band by allocating physical links 80 dedicated to specific traffics in a band control device with a trunking function that is applied to an end device 1, a relay 2 and the like.

Japanese Patent Laid Open Publication No. 2002-237841 (Patent Document 3) discloses a technique for performing easy and even redistribution of an extra band, while ensuring a packet transfer rate equal to or higher than the minimum guaranteed rate, even when traffic has increased, in a packet communication network in which the minimum guaranteed rate and maximum limiting rate of packet transfer are contracted for each service.

Japanese Patent Laid Open Publication No. 2006-5437 (Patent Document 4) discloses a technique for performing even band distribution to a plurality of physical ports that constitute a logical port for Link Aggregation.

Japanese Patent Laid Open Publication No. 2007-180891 (Patent Document 5) discloses a technique for leveling out traffics of respective physical ports that constitute a Link Aggregation.

In the above-described Japanese Patent Laid Open Publication No. 2002-232427, Japanese Patent Laid Open Publication No. 2002-237841, Japanese Patent Laid Open Publication No. 2006-5437, and Japanese Patent Laid Open Publication No. 2007-180891 (Patent Documents 2 to 5) as in U.S. Pat. No. 6,910,149 (Patent Document 1), neither mention nor suggest that they control a band of the LAG group between the devices and necessity of the controlling.

### SUMMARY

An exemplary object of the present invention is to provide a communication device, a communication system, a communication control method, and a recording medium recording a communication control program that are capable of performing band control on a LAG group between devices.

### <Communication Device>

A communication device according to an exemplary aspect of the present invention includes:

managing means for managing output ports of a LAG (Link Aggregation) group between devices for each LAG group; and

control means for controlling flows transmitted from the output ports for each LAG group, when traffic of the output ports deviates.

### <Communication System>

A communication system according to an exemplary aspect of the present invention including a plurality of communication devices, wherein each of the communication devices includes:

managing means for managing output ports of a LAG (Link Aggregation) group between devices for each LAG group; and

control means for controlling flows transmitted from the output ports for each LAG group, when traffic of the output ports deviates.

### <Communication Control Method>

A communication control method according an exemplary aspect of to the present invention used in a communication device that manages output ports of a LAG (Link Aggregation) group between devices for each LAG group, includes

a controlling step of controlling flows transmitted from the output ports for each LAG group, when traffic of the output ports deviates.

### <Recording Medium>

An exemplary aspect in accordance with the present invention is a recording medium that records a communication control program to be executed by a communication device that manages output ports of a LAG (Link Aggregation) group between devices for each LAG group, wherein

a control process for controlling flows transmitted from the output ports for each LAG group is executed by the communication device, when traffic of the output ports deviates.

### BRIEF DESCRIPTION OF THE DRAWINGS

The exemplary objects and features of the present invention will become more apparent from the consideration of the following detailed description taken in conjunction with the accompanying drawings, in which:

FIG. 1 is a diagram showing an example of a system configuration of a communication system of an exemplary embodiment of the present invention;

FIG. 2 is a diagram showing an example of an inner configuration of an MDLA node (M);

FIG. 3 is a diagram showing an example of an inner configuration of an edge (E);

FIG. 4 is a first diagram showing an example of a system configuration for illustrating a process in the communication system of the exemplary embodiment; and

FIG. 5 is a second diagram showing an example of a system configuration for illustrating a process in the communication system of the exemplary embodiment.

### DESCRIPTION OF THE EXEMPLARY EMBODIMENTS

### <Outline of Communication System>

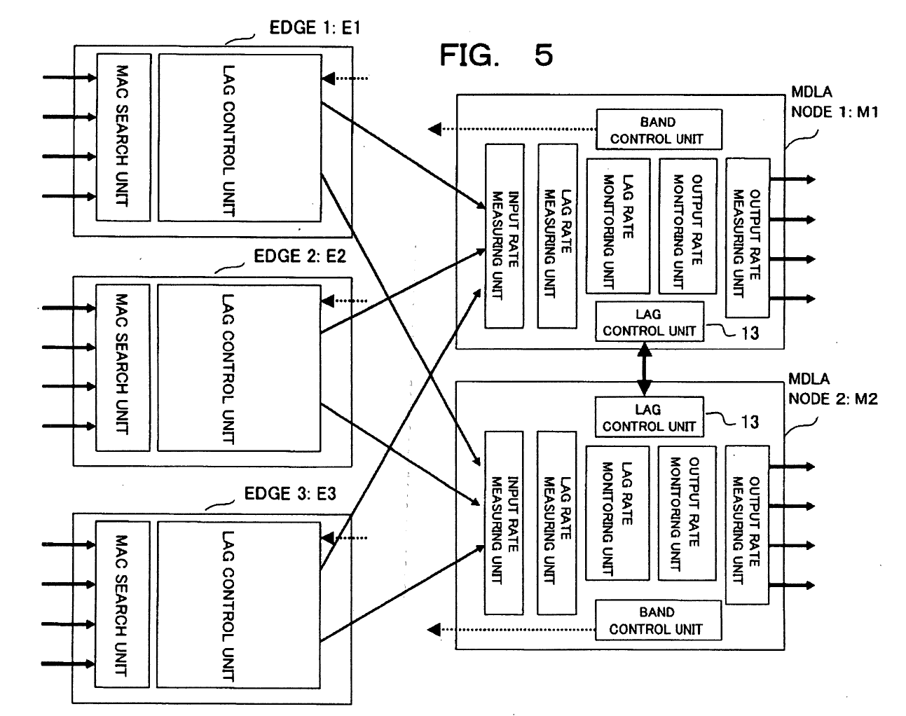

First, a communication system of an exemplary embodiment of the present invention will be outlined with reference to FIG. 5.

The communication system of the exemplary embodiment includes a plurality of communication devices (M1, M2, and E1 to E3).

Each of the communication devices (E1 to E3) manages output ports of LAG (Link Aggregation) groups between the devices (M1 and M2) for each LAG group. When traffic of the output ports deviates, each of the communication devices (E1 to E3) controls flows to be transmitted from the output ports for each LAG group.

That enables the communication system of the exemplary embodiment to perform the band control on the LAG groups between devices (M1 and M2). The communication system of the exemplary embodiment will be detailed below with reference to the attached drawings.

### <Example of System Configuration of the Communication System of the Exemplary Embodiment>

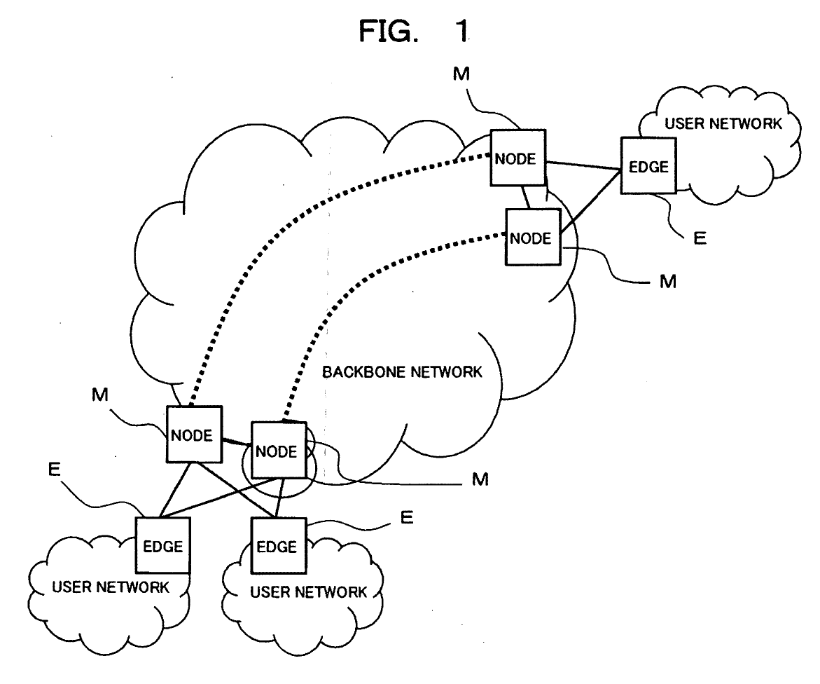

First, an example of a system configuration of the communication system of the exemplary embodiment will be described with reference to FIG. 1. FIG. 1 is a diagram showing an example of a system configuration of the communication system of the exemplary embodiment.

The communication system of the exemplary embodiment includes MDLA (Multi-Device Link Aggregation) nodes (M) and edges (E).

The MDLA nodes (M) connect with the edge (E) and relay a frame transmitted from the edge (E).

The edge (E) transmits a frame to the MDLA node (M).

In the system configuration shown in FIG. 1, the MDLA nodes (M) connect with a backbone network, while the edges (E) connect with user networks.

The backbone network is a relatively large network such as provided by a service provider. A backbone network topology may have various configurations such as a mesh network, a ring network and the like. The backbone network topology is not particularly limited to those described above and may be applied with various topologies.

The user networks connect with each other via the backbone network.

FIG. 1 shows an example of a connection between the user network and the backbone network. The network configuration for making the communication system is not particularly limited to that shown in FIG. 1 and may be applied with any network configurations such that the communication system can be configured with only the backbone network.

The MDLA nodes (M) of the exemplary embodiment configure the LAG between the devices. The edge (E) connecting with the MDLA nodes (M) recognizes those MDLA nodes (M) as if they are a single MDLA node (M) that supports the LAGs in the communication. The MDLA nodes (M), which connect with each other via a line, exchange control information and manage the LAG group between the devices.

### <Example of Inner Configuration of MDLA Node; M>

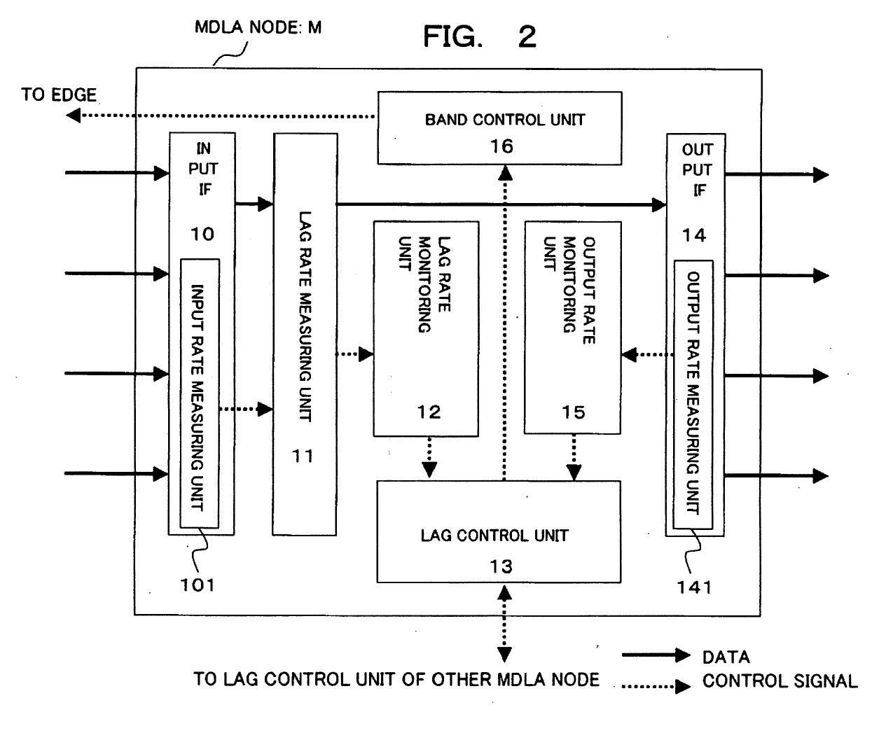

Now, an example of an inner configuration of the MDLA node (M) of the exemplary embodiment will be described with reference to FIG. 2. FIG. 2 is a diagram showing an example of an inner configuration of the MDLA node (M).

The MDLA node (M) of the exemplary embodiment includes an input IF (10), a LAG rate measuring unit (11), a LAG rate monitoring unit (12), a LAG control unit (13), an output IF (14), an output rate monitoring unit (15), and a band control unit (16).

The input IF (10) receives a frame. The input IF (10) includes an input rate measuring unit (101). The input rate measuring unit (101) measures the traffic rate of the input IF (10).

The LAG rate measuring unit (11) measures the traffic rate of the input IF (10) for each flow. The flows can be classified for each of the edges (E).

The LAG rate monitoring unit (12) adds up the traffic rates, which have been measured at the LAG rate measuring unit (11) by the flow, for each LAG port. Then, the LAG rate monitoring unit (12) monitors whether the rate toward the LAG port is equal to or more than the physical band or not based on the sum of the traffic rates for each LAG port. The LAG rate monitoring unit (12) informs the LAG control unit (13) of the sum for each LAG port and the monitored result. The monitored result is information for determining whether the rate toward the LAG port is equal to or more than the physical band or not.

The output IF (14) transmits a frame. The output IF (14) includes an output rate measuring unit (141). The output rate measuring unit (141) measures the traffic rate of the output IF (14). If the output IF (14) includes a plurality of output ports, the output rate measuring unit (141) measures the traffic rate for each of the output ports.

The output rate monitoring unit (15) calculates an extra band of each output port and the output rate for each LAG group based on the information on the traffic rate for each output port that has been measured at the output rate measuring unit (141). The output rate monitoring unit (15) informs the LAG control unit (13) of information on the extra band of each output port and the output rate for each LAG group.

The LAG control unit (13) recognizes information on the input and output rates of the entire LAG group by causing the MDLA nodes (M) constituting the LAGs between the devices to exchange control information. The control information may include information on the output rate for each LAG group that has been output from the output IF (14) and information on the input rate for each LAG group that has been input in the input IF (10). The LAG control unit (13) informs the band control unit (16) of the information on the input and output rates.

The band control unit (16) controls the transmission by the edge (E) by analyzing the information on the input and output rates collected from the LAG control unit (13) and transmitting a control request to an upstream edge (E) according to the analysis result. Specifically, if the band control unit (16) determines based on the analysis result that the upstream edge (E) transmits a frame at rate more than the rate that the output IF (14) can output, the band control unit (16) transmits the control request to the edge (E) in order to reduce the transmission rate of the edge (E) or redirect the flow from the edge (E).

### <Example of Inner Configuration of Edge; E>

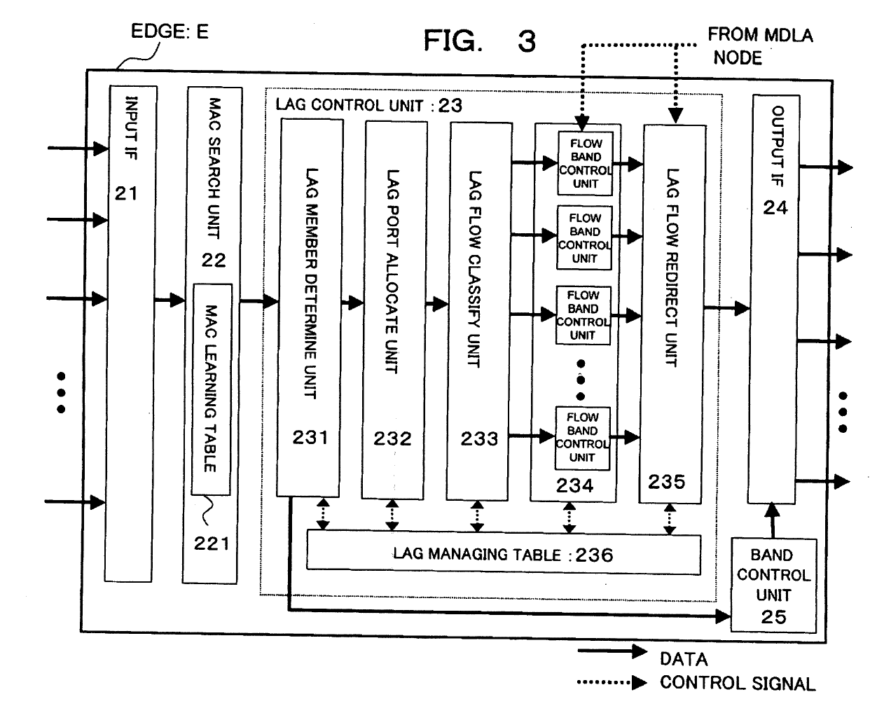

Now, an example of an inner configuration of the edge (E) of the exemplary embodiment will be described with reference to FIG. 3. FIG. 3 is a diagram showing an example of an inner configuration of the edge (E).

The edge (E) includes an input IF (21), a MAC search unit (22), a LAG control unit (23), an output IF (24), and a band control unit (25).

The input IF (21) receives a frame.

The MAC search unit (22) searches a MAC learning table (221) with a destination MAC address of the frame received at the input IF (21) as a search key in order to decide the output port from which the frame is to be transmitted. The MAC learning table (221) stores learned results of the relationship between the MAC address and the output port. The MAC search unit (22) decides the output port from which the frame is transmitted with reference to the information managed in the MAC learning table (221).

The LAG control unit (23) includes a LAG member determine unit (231), a LAG port allocate unit (232), a LAG flow classify unit (233), a flow band control unit (234), and a LAG flow redirect unit (235).

The LAG member determine unit (231) determines whether the output port decided by the MAC search unit (22) is a LAG member port or not with reference to the information managed in a LAG managing table (236). The LAG managing table (236) manages information on the LAG group and output ports that belong to the LAG group. If the output port decided by the MAC search unit (22) belongs to the LAG group, the LAG member determine unit (231) determines that the output port is the LAG member port. If the output port does not belong to the LAG group, the LAG member determine unit (231) determines that the output port is not the LAG member port.

The LAG port allocate unit (232) selects the LAG port to allocate the frame according to an allocation algorithm. With the allocation algorithm, a LAG port is selected according to a desired calculation algorithm based on values (of MAC address, VLAN tag, IP address, and the like) in a header field of the frame. The LAG port allocate unit (232) selects the LAG port to allocate the frame by an approach for deciding the LAG port based on the value of the lowest three bits of the destination MAC address. For example, frames whose values of the lowest three bits are 0, 2, 4, and 6 are allocated to a LAG port 1, and frames whose values of the lowest three bits are 1, 3, 5, and 7 are allocated to a LAG port 2. The above-described approach is merely an example and the edge can be built to select the LAG port by various approaches. When the LAG port allocate unit (232) receives a link failure notice, the LAG port allocate unit (232) switches between the LAG ports to output the frame.

The LAG flow classify unit (233) classifies the traffic toward the LAG group into flows according to a certain rule. The flow in this context refers to the traffic that is classified by the further fractionalized rate than that the LAG port allocate unit (232) allocates the frame to each LAG port. In the exemplary embodiment, the more the number of flows the LAG flow classify unit (233) to classify, the lower the rate of each flow can be and more flexible band control can be achieved. The rule for classifying flows may be the methods for classifying flows according to the type of Ethernet header, VLAN ID or TPID of VLAN tag, IP address of IP header, protocol or the like in the frame field, or the methods for hashing the flows by a combination thereof.

The flow band control unit (234) performs band control by the flow according to the control request received from a downstream MDLA node (M). Specifically, when the flow band control unit (234) receives a flow reduce request from the MDLA node (M), the flow band control unit (234) performs reduce control on the flow according to the rate in the flow reduce request. For example, when the flow band control unit (234) receives the flow reduce control for 200 Mbps from the MDLA node (M1), the flow band control unit (234) stops transmitting the 200 Mbps flow among the flows toward the MDLA node (M1). If the flow band control unit (234) cannot satisfy the flow reduce request by stopping the transmission of one flow, the flow band control unit (234) controls the sum of a plurality of flows on which the flow band control unit (234) is to perform rate reduction equal to or more than the rate in the flow reduce request.

The LAG flow redirect unit (235) performs flow redirect control according to the control request that the LAG flow redirect unit (235) receives from a downstream MDLA node (M). Specifically, when the LAG flow redirect unit (235) receives the flow redirect request from the MDLA node (M), the LAG flow redirect unit (235) redirects the flow to the LAG port for outputting the frames according to the rate in the flow redirect request. For example, when the LAG flow redirect unit (235) receives the flow redirect request for 200 Mbps from the MDLA node (M1), the LAG flow redirect unit (235) redirects the flow within 200 Mbps among the flows toward the MDLA node (M1) to the MDLA node (M2). If the rate is within that informed from the MDLA node (M1), the LAG flow redirect unit (235) can redirect even a plurality of flows to another MDLA node (M2).

### <Process in Communication System>

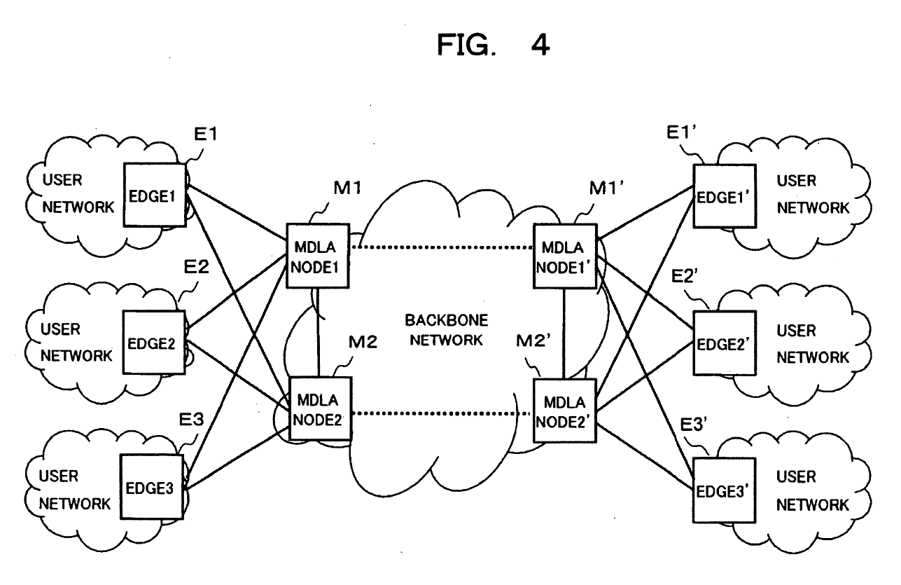

Now, a series of processes in the communication system of the exemplary embodiment will be described with reference to FIG. 2 to FIG. 5. FIG. 4 and FIG. 5 are diagrams showing an example of a system configuration used for illustrating processes in the communication system of the exemplary embodiment.

In the system configuration shown in FIG. 4 and FIG. 5, the edges (E1, E2, and E3) connect with the MDLA nodes (M1 and M2). The MDLA nodes (M1 and M2) have the LAGs therebetween. Accordingly, the MDLA node (M1) and the MDLA node (M2), which are connect with each other via the LAG control units (13) as shown in FIG. 5, manage the LAG group therebetween by exchanging control information. The control information includes information on the output rate for each LAG group that is output from the output IF (14) shown in FIG. 2 and information on the input rate for each LAG group that is input into the input IF (10).

### <Edge; E Side Process>

First, the process in the edge (E1) will be described.

Here, the edge (E1) receives the frame by the input IF (12) shown in FIG. 3 and transmits the frame to the LAG group 1. The LAG group 1 consists of the MDLA nodes (M1 and M2). The LAG group 1 includes the output port 1 and the output port 2 which are called the LAG port 1 and the LAG port 2, respectively. The LAG port 1 of the edge (E1) connects with the MDLA node (M1) and the LAG port 2 connects with the MDLA node (M2).

In FIG. 3, when the edge (E1) receives the frame by the input IF (21), the edge (E1) transmits the received frame to the MAC search unit (22). The MAC search unit (22) searches the MAC learning table (221) with the destination MAC address of the frame as the search key in order to decide the output port from which the frame is to be transmitted. The MAC search unit (22) transmits information on the frame and the output port from which the frame is to be output to the LAG control unit (23).

The LAG member determine unit (231) of the LAG control unit (23) determines whether the output port decided by the MAC search unit (22) is the LAG member port or not with reference to the LAG managing table (236) based on information on the output port that is decided by the MAC search unit (22).

If the LAG member determine unit (231) determines that the output port decided by the MAC search unit (22) is not the LAG member port, the LAG member determine unit (231) transmits information on the frame and the output port from which the frame is to be output to the band control unit (25). When the band control unit (25) receives the information on the frame and the output port from which the frame is to be output, the band control unit (25) performs band control on each output port.

If the LAG member determine unit (231) determines that the output port decided by the MAC search unit (22) is the LAG member port, the LAG member determine unit (231) transmits the information on the frame and the output port from which the frame is to be output to the LAG port allocate unit (232).

When the LAG port allocate unit (232) receives the information on the frame and the output port from which the frame is to be output, the LAG port allocate unit (232) selects the LAG port to allocate the frame according to an allocation algorithm. In the exemplary embodiment, the LAG port allocate unit (232) selects the LAG port to allocate the frame by an approach using allocation algorithm for deciding the LAG port based on the value of the lowest three bits of the destination MAC address. For example, frames whose values of the lowest three bits are 0, 2, 4, and 6 are allocated to a LAG port 1, and frames whose values of the lowest three bits are 1, 3, 5, and 7 are allocated to a LAG port 2. The above-described approach is merely an example and the edge can be built to select the LAG port by various approaches.

Then, the LAG flow classify unit (233) classifies the frames toward the LAG member port according to a certain rule by further fractionalized rate than that for allocating the frame toward the LAG member port for each LAG port.

The flow band control unit (234) performs band control by the flow according to the control request from the MDLA node (M). The LAG flow redirect unit (235) performs redirect control on the flows according to the control request from the MDLA node (M).

<MDLA Node; M side Process>

Now, the process in the MDLA node (M) will be described. Here, the MDLA node (M1) is receiving frames from the edges (E1, E2, and E3).

At the input IF (10) side that receives the frames transmitted from the edges (E1, E2, and E3), the LAG rate measuring unit (11) measures the traffic rate of the input IF (10) for each flow (edges; E1, E2, and E3) and informs the LAG rate monitoring unit (12) of the traffic rates.

The LAG rate monitoring unit (12) adds up the traffic rates, which have been informed from the LAG rate measuring unit (11), for each LAG port. Then, the LAG rate monitoring unit (12) monitors whether the rate toward the LAG port is equal to or more than the physical band or not based on the sum of the traffic rates added up for each LAG port. The LAG rate monitoring unit (12) informs the LAG control unit (13) of the sum for each LAG port and the monitored result. The monitored result is information for determining whether the rate toward the LAG port is equal to or more than the physical band or not.

The LAG control unit (13) informs the band control unit (16) of information on the rate toward the LAG port that is equal to or more than the physical band and information on the rate (rate by the flow) at which each of the edges (E1, E2, and E3) transmits the frame based on the sum of the traffic rates for each LAG port and the monitored result that have been informed from the LAG rate monitoring unit (12).

On the other hand, at the output IF (14) side of the MDLA node (M), the output rate measuring unit (141) measures the traffic rate of the output IF (14) for each output port and informs the output rate monitoring unit (15) of the traffic rates.

The output rate monitoring unit (15) calculates an extra band of each output port and the output rate for each LAG group based on the information on the traffic rate for each output port that has been informed from the output rate measuring unit (141). The output rate monitoring unit (15) informs the LAG control unit (13) of information on the extra band of each output port and the output rate for each LAG group.

The LAG control unit (13) obtains information on the output rate from the LAG control unit (13) of the other MDLA node (M2), and based on the obtained information on the output rate and the information on the output rate informed from the output rate monitoring unit (15), recognizes information on the output rate that is output from the entire LAG group. Then, the LAG control unit (13) determines whether the output rate from the entire LAG group violates the band allocated to the LAG group or not based on the information on-the output rate from the entire LAG group.

The LAG control unit (13) adds up the output rates for each LAG group that have been informed from the output rate monitoring unit (15) and the LAG control unit (13) of the other MDLA node (M2). If the sum of the output rates for each LAG group exceeds the rate allocated for each LAG group, the LAG control unit (13) informs the band control unit (16) of the extra rate. If the rate allocated for each LAG group is exceeded, the LAG control unit (13) needs to decide how much of the traffic is to be reduced toward which MDLA node. For example, if the rate allocated to the LAG group 1 exceeds 200 Mbps, there may be a method for controlling the MDLA node (M1) that has the larger sum of the output rates to reduce 200 Mbps for the simplicity of control. The MDLA node can be built to allocate a reduced rate proportional to the sum of the rates output from the MDLA node or the sum of the rate for each LAG group.

The band control unit (16) collects information on the rate toward the LAG port that is equal to or more than the physical band, information on the rate that exceeds the rate allocated for each LAG group, and information on the rate at which each of the edges (E1, E2, and E3) transmits the frame (input rate toward the MDLA node) from the LAG control unit (13). The band control unit (16) controls the transmission by the edges (E1, E2, and E3) placed at the upstream based on the above-described information collected from the LAG control unit (13). Specifically, if the band control unit (16) determines that the frames are transmitted from the upstream edges (E1, E2, and E3) at the rate equal to or more than that can be output from the output IF (14) based on the information collected from the LAG control unit (13), the band control unit (16) reduces the transmission rate from the edges (E1, E2, and E3) (reduce control) or redirects the frames from the edges (E1, E2, and E3) from the MDLA node (M1) to the MDLA node (M2) for the destination of the frame transmission (redirect control).

In the cases below, the transmission from the upstream edges (E1, E2, and E3) should be controlled.

The case in which the input rate of the traffic to the input IF (10) exceeds the physical rate of the LAG port of the output IF (14)

The case in which the input rate of the traffic to the input IF (10) does not exceed the physical rate of the LAG port of the output IF (14) but the sum of the input rates in the LAG group exceeds the physical rate of the LAG port allocated to the LAG group

The band control unit (16) calculates reducing rates for reducing the transmission rates of the flows from the edges (E1, E2, and E3) according to the rate ratios of traffic from the edges (E1, E2, and E3) at the input IF (10) respectively, and informs the upstream edges (E1, E2, and E3) of the calculated reducing rates (flow reduce request). The sum of the rates to be informed to the upstream edges (E1, E2, and E3) is equal to or more than the value of the part of the above-described physical rate of the LAG port that is exceeded. The band control unit (16) can keep fairness of the reduce control among the upstream edges (E1, E2, and E3) by informing the edges (E1, E2, and E3) of the reducing rates in accordance with the rate ratios of the traffic of respective edges (E1, E2, and E3).

There is a case in which the input rate of the traffic to the input IF (10) exceeds the physical rate of the LAG port of the output IF (14) but the sum of the input rates in the LAG group does not exceed the physical rate of the LAG port allocated to the LAG group. That means that the physical rate of the LAG port of the MDLA node (M1) is exceeded but the physical rate of the LAG port of the MDLA node (M2) is not exceeded. In that case, since the LAG port of the MDLA node (M2) has an extra band, the band control unit (16) calculates the extra band of the LAG port of the MDLA node (M2), distributes the calculated extra band according to the rate ratios of the traffic of the edges (E1, E2, and E3), and informs the upstream edges (E1, E2, and E3) of the distributed extra bands. If the value of the part that exceeds the physical rate of the LAG port of the MDLA node (M1) exceeds the extra band of the LAG port of the MDLA node (M2), the band control unit (16) performs the above-described reduce control and informs the upstream edges (E1, E2, and E3) of the reducing rates according to the rate ratio of the traffic of the edges (E1, E2, and E3).

When the LAG control unit (23) of each of the edges (E1, E2, and E3) receives the rate control request, the flow band control unit (234) performs the reduce control on the flow according to the reducing rate in the flow reduce request such that the flow band control unit (234) selects the flow to discard among the flows whose rates are higher than the reducing rate and discards the selected flow. For example, if the LAG control unit (23) receives the flow reduce request for 200 Mbps from the MDLA node (M1), the LAG control unit (23) causes the flow band control unit (234) to stop the transmission of the flow at 200 Mbps among the flows toward the MDLA node (M1). If the LAG control unit (23) cannot satisfy the flow reduce request by stopping the transmission of one flow, the LAG control unit (23) causes the flow band control unit (234) to control the sum of a plurality of flows on which the LAG control unit (23) is to perform rate reduction to be equal to or more than the rate in the flow reduce request.

When the LAG control unit (23) receives the flow redirect request, the LAG flow redirect unit (235) performs the redirect control on the flow according to the redirect rate in the flow redirect request such that the LAG flow redirect unit (235) selects the flow to redirect among the flows and redirects the selected flow to another MDLA node. For example, if the LAG control unit (23) receives the flow redirect request for 200 Mbps from the MDLA node (M1), the LAG control unit (23) causes the LAG flow redirect unit (235) to redirect the flow within 200 Mbps among the flows toward the MDLA node (M1) to the MDLA node (M2). If the rate is within that informed from the MDLA node (M1), the LAG flow redirect unit (235) can redirect a plurality of flows to another MDLA node (M2).

### <Operation and Advantages of Communication System of the Exemplary Embodiment>

As mentioned above, in the communication system of the exemplary embodiment, the MDLA nodes (M1 and M2) form the LAGs between the devices (M1 and M2) so that the LAGs are virtually controlled as one LAG. Then, each of the edges (E1, E2, and E3) manages the output ports of the LAG groups between the MDLA nodes (M1 and M2) for each LAG group. When the traffic of the output ports deviates, each of the edges (E1, E2, and E3) controls the flows to be transmitted from the output ports for each LAG group. Accordingly, the edges can perform the band control on the LAG groups between the devices (M1 and M2).

In the communication system of the exemplary embodiment, if the physical rate of one of the output ports that constitute the LAG group is exceeded, or if the contracted rate is exceeded, the flow reduce control or the flow redirect control is performed.

For example, in FIG. 4 and FIG. 5, if the upstream edges (E1, E2, and E3) transmit the flows at 10 Mbps, 20 Mbps, and 30 Mbps respectively to one output port of the MDLA node (M1) whose contracted rate is 40 Mbps, that results in 20 Mbps (sum of bands; 60 Mbps—contracted rate; 40 Mbps) of violating band. The communication system of the exemplary embodiment evenly performs the rate reduce control for the 20 Mbps of violating band on the upstream edges (E1, E2, and E3) at the ratio of 10 Mbps: 20 Mbps: 30 Mbps. Accordingly, the communication system can keep fairness of the reduce control among the edges (E1, E2, and E3).

When usage information (control information) of the output ports is exchanged between the MDLA nodes (M1 and M2) and, according to the information, the MDLA node (M2) side is found to have the extra band, the communication system controls the 20 Mbps of the violating band to be redirected to the MDLA node (M2) side. Accordingly, the communication system can effectively use the extra band.

The configuration of the MDLA node (M) shown in FIG. 2 can be provided with the functions of the MAC search unit (22) and the LAG control unit (23) of the edge (E) shown in FIG. 3. In that case, a plurality of MDLA nodes (M) is placed to each other to transmit and receive data.

The devices constituting the communication system in the exemplary embodiment can be controlled by hardware, software, or a combination thereof.

The processing can be performed by means of software by installing the program that records the processing sequence in a memory of a computer that is integrated in a dedicated hardware device. Alternatively, the processing can be performed by installing the program in a general purpose computer that can perform various types of processing.

For example, the program can be recorded in a hard disk or a ROM (Read Only Memory) as a recording medium in advance. Alternatively, the program can be temporally or permanently stored (recorded) in a removable recording medium. That kind of removable recording medium can be provided as a so-called package software program. The removable recording media include a floppy (registered trademark) disk, a CD-ROM (Compact Disc Read Only Memory), an MO (Magneto optical) disk, a DVD (Digital Versatile Disc), a magnetic disk, and a semiconductor memory.

The program is installed from the above-described removable recording medium to a computer, wirelessly transferred from a download site to the computer, or transferred to the computer by wire over a network.

The communication system of the exemplary embodiment can be adapted not only to perform the processing in time series along with the processes described in the above-described embodiment but also to perform the processing in parallel or individually according to the throughput of the device that performs the processing or as required.

The present invention can be applied to an apparatus that constitutes the LAG between devices.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication device comprising:
a managing unit which manages output ports of a LAG (Link Aggregation) group between devices for each LAG group; and
a control unit which controls flows transmitted from the output ports for each LAG group, when traffic of the output ports deviates.

2. The communication device according to claim 1, wherein
the control unit controls the flows in accordance with rate ratios of flows transmitted from the output ports that are included in the LAG group.

3. The communication device according to claim 1, wherein
the control unit controls the flows so as to satisfy a reduce request for the flows when the control unit receives the reduce request from a downstream communication device that connects with the output ports.

4. The communication device according to claim 3, wherein
the reduce request includes reducing rates for reducing the flows; and
the control unit reduces the flows by the reducing rates.

5. The communication device according to claim 1, wherein
the control unit controls the flows so as to satisfy a redirect request for the flows when the control unit receives the redirect request from a downstream communication device that connects with the output ports.

6. The communication device according to claim 5, wherein
the redirect request includes redirecting rates for redirecting the flows; and
the control unit redirects the flows by the redirecting rates.

7. A communication system comprising a plurality of communication devices, wherein each of the communication devices comprises:
a managing unit which manages output ports of a LAG (Link Aggregation) group between devices for each LAG group; and
a control unit which controls flows transmitted from the output ports for each LAG group, when traffic of the output ports deviates.

8. A communication control method used in a communication device that manages output ports of a LAG (Link Aggregation) group between devices for each LAG group, comprising
a controlling step of controlling flows transmitted from the output ports for each LAG group, when traffic of the output ports deviates.

9. A recording medium that records a communication control program to be executed by a communication device that manages output ports of a LAG (Link Aggregation) group between devices for each LAG group, wherein
a control process for controlling flows transmitted from the output ports for each LAG group is executed by the communication device, when traffic of the output ports deviates.

10. A communication device comprising:
managing means for managing output ports of a LAG (Link Aggregation) group between devices for each LAG group; and
control means for controlling flows transmitted from the output ports for each LAG group, when traffic of the output ports deviates.

11. A communication system comprising a plurality of communication devices, wherein each of the communication devices comprises:
managing means for managing output ports of a LAG (Link Aggregation) group between devices for each LAG group; and
control means for controlling flows transmitted from the output ports for each LAG group, when traffic of the output ports deviates.
